(19) United States
(12) Patent Application Publication
(10) Pub. No.: US 2015/0258609 A1
(43) Pub. Date: Sep. 17, 2015

(54) METHOD FOR PRODUCING A THREE-DIMENSIONAL OBJECT

(71) Applicant: PHENIX SYSTEMS, Riom (FR)

(72) Inventor: Patrick Teulet, Riom (FR)

(21) Appl. No.: 14/418,103

(22) PCT Filed: Jul. 30, 2013
(86) PCT No.: PCT/EP2013/066021

§ 371 Date: Jan. 29, 2015

(30) Foreign Application Priority Data
Jul. 30, 2012 (FR) 1257369

(51) Int. Cl. B22F 3/105; B28B 1/00

(52) U.S. Cl. CPC B22F 3/1055; B28B 1/001; B22F 2003/1058; B33Y 10/00

(57) ABSTRACT

Method for producing a three-dimensional object from a powder or mixture of powders by sintering and/or laser melting includes manufacturing steps of: depositing, compacting, then solidifying, in predetermined areas, successive layers of the powder or mixture of powders, and the following steps: a) before implementing the manufacturing steps, manufacturing, by sintering and/or laser melting, a support whose surface or surfaces oriented towards the three-dimensional object to be manufactured are respectively homothetic to surfaces opposite the object; b) manufacturing, by sintering and/or laser melting, blades for supporting the object on the support produced in step a); c) manufacturing the object from the upper surfaces of the blades manufactured in step b) and d) when the manufacturing of object is complete, detaching the object from the support by applying a force to the object or to the support, moving the object and the support relative to one another until the blades break.

The invention relates to a method for producing a three-dimensional object from a powder or from a mixture of powders by sintering, also called laser melting, comprising manufacturing steps consisting of depositing, compacting, then solidifying, in predetermined areas, successive layers of powder.

Powder here refers to a powdered material made up of one or more elements as well as a mixture of several powdered materials. These powders can be metal or mineral, for example a ceramic powder. It is known to produce objects, with a more or less complex shape, from such a powder by solidifying, by melting under the effect of heat energy supplied by a laser, certain areas of the powder previously spread and compacted in a series of thin layers. Hereinafter, the terms “sintering” and “laser melting” will refer to such solidification by laser treatment. Each powder layer is sintered only at the areas intended to form the finished object, before spreading and compacting of that layer, and so forth, layer after layer.

The known methods for producing three-dimensional objects by sintering have the drawback of requiring the implementation of several complementary steps, in particular machining or cutting, in order to separate the manufactured three-dimensional object from its manufacturing platform, and/or operations to resume machining on the object after it has been separated from its manufacturing table. These additional steps are necessary to meet the dimensional, geometric and surface state requirements. In fact, the areas of the three-dimensional object in contact with the manufacturing table are modified by the presence of maintenance and positioning interfaces extending between the three-dimensional object and the manufacturing platform, thereby forming a support. These additional steps are in particular carried out using digitally controlled machining machines or by cutting using wire electro-erosion.

In the event the object to be manufactured includes undercut surfaces, i.e., surfaces oriented obliquely toward the manufacturing table, they may be of deteriorated quality, otherwise it is necessary to maintain them with supports, interfaces between the undercut surface and the manufacturing table.

It is known from DE-A-199 54 891 to support the object to be manufactured using a support structure, also made by sintering, made up of parallelepiped cells topped by vertical rods from which the three-dimensional object is manufactured. The relatively large number of support rods can make it awkward to detach the support structure and may cause unsatisfactory surface states of the manufactured object.

The invention more particularly aims to resolve these drawbacks by proposing a new method for producing a three-dimensional object, making it possible to obtain such a three-dimensional object whose geometric, dimensional and surface state characteristics are of a quality at least equivalent to, or greater than, objects produced using the methods known from the state of the art, and whose supports can be removed without any particular difficulty and while avoiding elaborate industrial processes.

To that end, the invention relates to a method for producing a three-dimensional object from a powder or from a mixture of powders by sintering and/or laser melting, comprising manufacturing steps consisting of depositing, compacting, then solidifying, in predetermined areas, successive layers of the powder or of the mixture of powders, further comprising the following steps:
a) before implementing the steps of manufacturing the three-dimensional object and from a manufacturing table, manufacturing, by sintering and/or laser melting, a support whereof the surface or the surfaces oriented toward the three-dimensional object to be manufactured are respectively homothetic to opposite surfaces of the three-dimensional object to be manufactured;
b) manufacturing, by sintering and/or laser melting, blades for supporting the three-dimensional object to be manufactured on the support manufactured in step a);
c) manufacturing, by sintering and/or laser melting, the three-dimensional object from an upper surface of the or each blade manufactured in step b);
d) when the manufacturing of the three-dimensional object is complete, detaching the three-dimensional object from the support by applying a force to the three-dimensional object or to the support, moving the object and the support relative to one another until the blade or the blades break.

Owing to the invention, the manufactured object is supported by blades from a support built by sintering before the three-dimensional object, which makes it possible to reduce the number and density of the elements supporting the weight of the manufactured object. The object is made easier to remove by the mechanical breaking of the support blades, obtained by moving the object and the support relative to one another. The subsequent operations for eliminating elements supporting the weight of the finished object are therefore considerably reduced, and the surface state of the finished object is improved as a result.

According to advantageous but optional aspects of the invention, such a method may incorporate one or more of the following features, considered in any technically allowable combination:
Before step d), this method comprises a step e) consisting of cutting the support near the or each blade.
Before step d), this method comprises a step f) consisting of separating the support into several parts by cuts that are made in the support perpendicular to the manufacturing table and which have a thickness substantially equal to the height of the blade of the blades.
In step b), the or each blade is manufactured with a height corresponding to the height of three to seven layers of powder or mixture of powders.
The blade or the blades are manufactured in planes perpendicular to the manufacturing table.
In step d), the force is applied on a force transmitting element comprising at least one surface cooperating by shape matching with a surface of the three-dimensional object.
In the event several three-dimensional objects are manufactured having increasing surface areas in a plane parallel to the manufacturing table, in step b) an increasing number of respective blades is manufactured for those objects.
In the event the three-dimensional object comprises one or more oblique faces relative to the manufacturing table and oriented toward the manufacturing table, the blades are manufactured aligned with the intersections of those faces with each other and/or with the other faces of the three-dimensional object.
In the event the three-dimensional object comprises one or more rounded faces oriented toward the manufacturing table, the blades are manufactured aligned with one or more generatrices of that or those rounded faces that are closest to the manufacturing table.
In the event the three-dimensional object comprises a series of walls forming angles relative to each other in a plane parallel to the manufacturing table, the or each blade is manufactured in a zone where two of those walls come together.

The invention will be better understood and other advantages thereof will appear more clearly in light of the following description of one embodiment of a method for producing a three-dimensional object according to its principle, and done in reference to the appended drawings, in which:

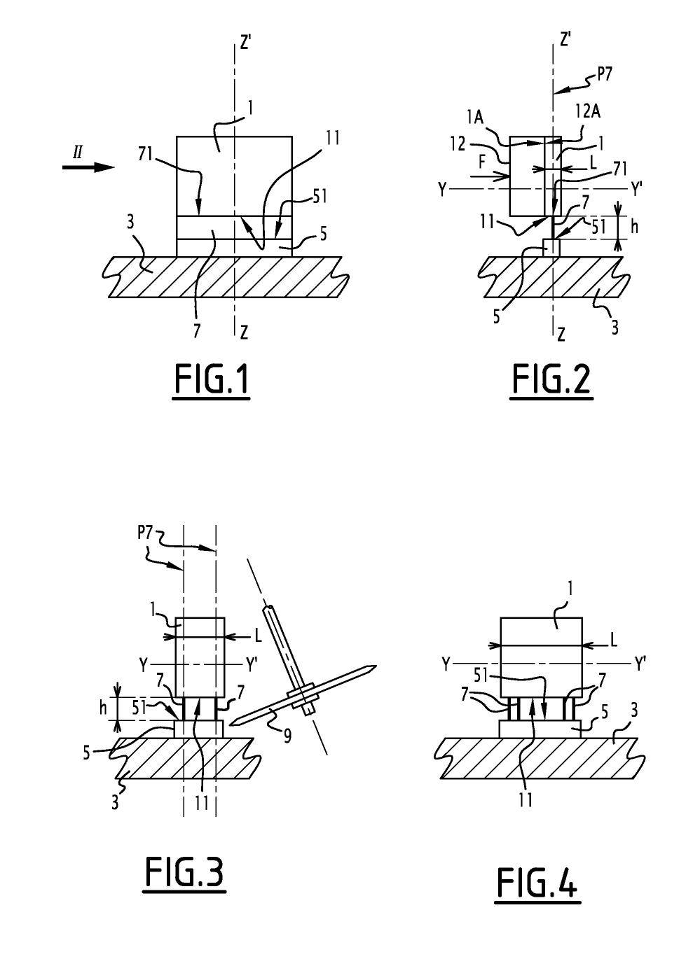

FIG. 1 is an elevation view of a three-dimensional object during the manufacture thereof using the method according to the invention,

FIG. 2 is a view of the object of FIG. 1, along arrow II,

FIG. 3 is a view similar to FIG. 2, for a second type of three-dimensional object,

FIG. 4 is a view similar to FIGS. 2 and 3, for a third type of three-dimensional object,

FIG. 5 is an elevation view similar to FIG. 1, for a fourth type of object,

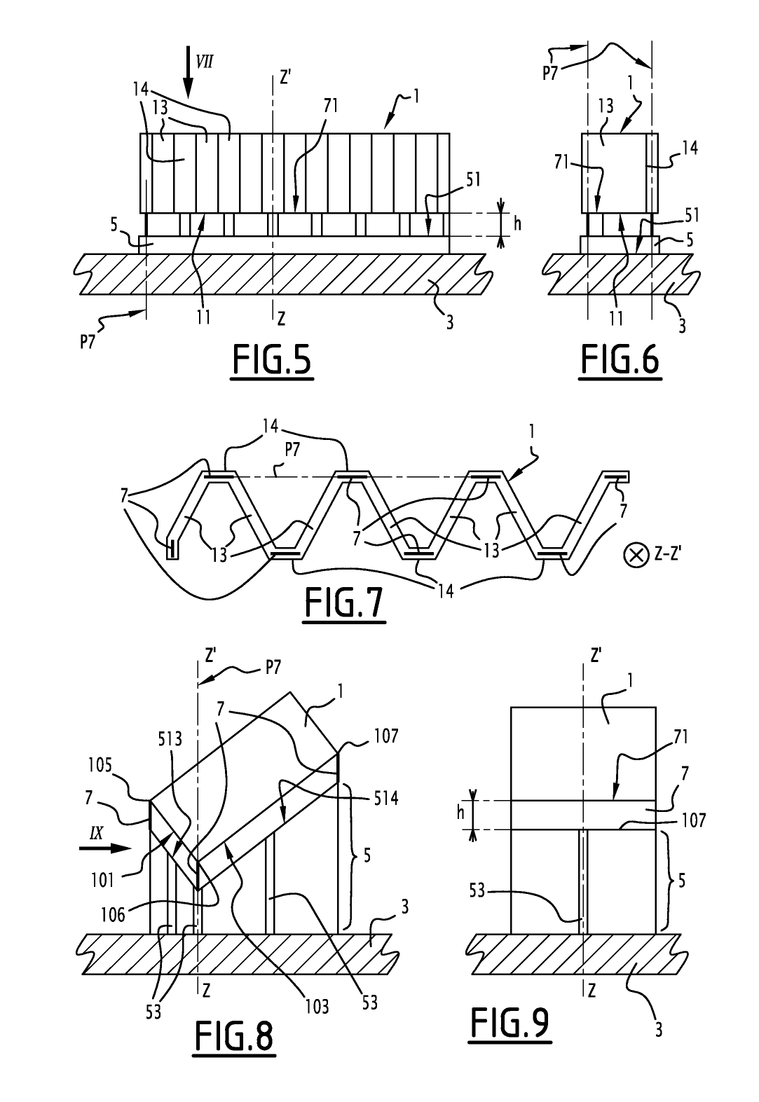

FIG. 6 is a view similar to FIGS. 2 to 4, for the object of FIG. 5,

FIG. 7 is a top view along arrow VII of the object of FIGS. 5 and 6,

FIG. 8 is an elevation view similar to FIG. 1, for a fifth type of object,

FIG. 9 is a view along arrow X of the object of FIG. 8,

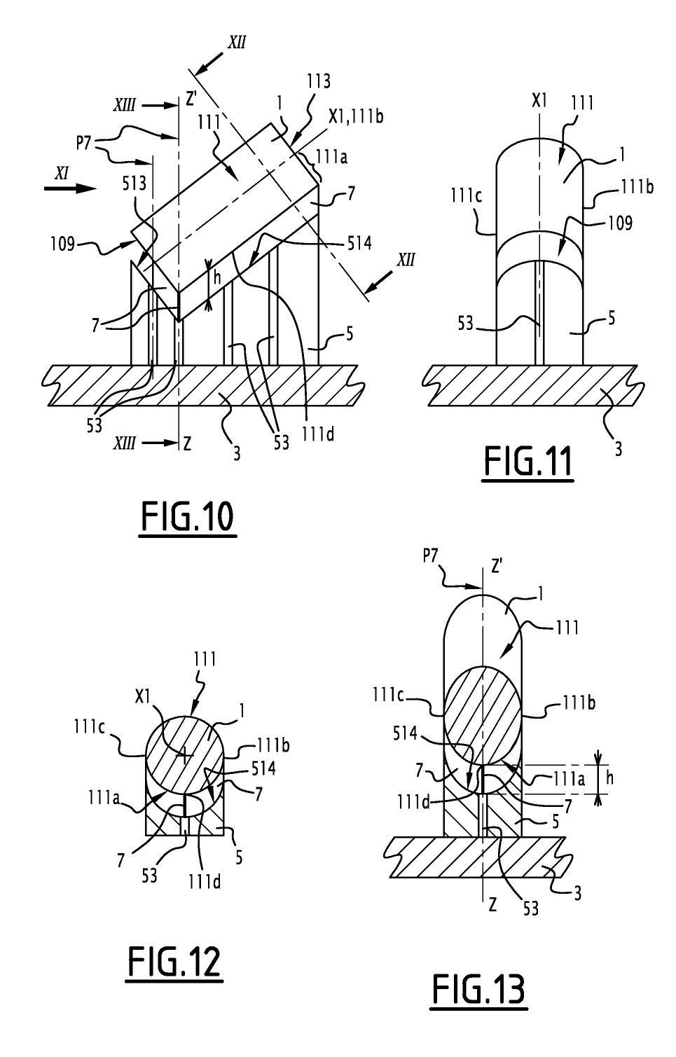

FIG. 10 is a view similar to FIG. 8 for a sixth type of object,

FIG. 11 is a view along arrow XI of the object of FIG. 10,

FIG. 12 is a cross-sectional view along plane XII-XII of the object of FIGS. 10 and 11,

FIG. 13 is a cross-sectional view along plane XIII-XIII of the object of FIGS. 10 to 12, and

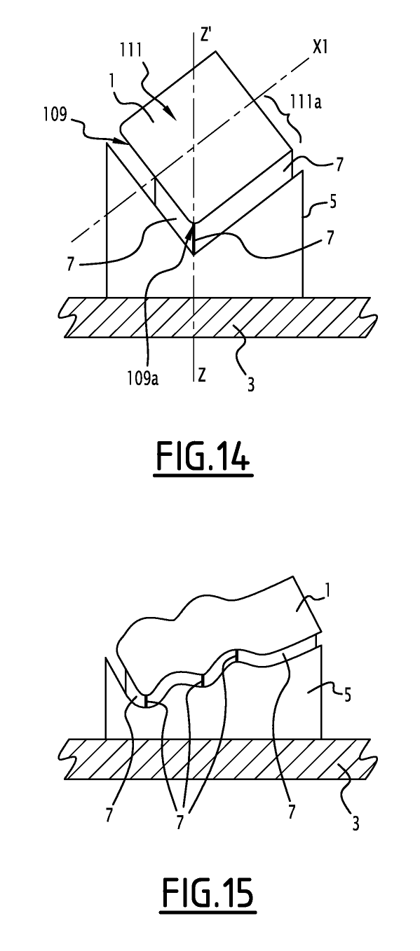

FIGS. 14 and 15 are views similar to FIG. 10, respectively illustrating alternatives of the object of FIGS. 10 to 13.

FIGS. 1 to 13 diagrammatically illustrate the production of a three-dimensional object 1 from powder or from a mixture of powders, either metallic or ceramic. The three-dimensional object 1 is manufactured on the manufacturing table 3, which is horizontal and perpendicular to a vertical axis Z-Z′.

Before manufacturing the object 1 strictly speaking, a support 5 making it possible to support the object 1 is manufactured from the table 3, by sintering using the same technique as to manufacture the object 1, using a known method involving depositing, compacting, then solidifying, in predetermined areas, successive layers of powder. Preferably, the support 5 is formed by one or more continuous blocks of material.

The support 5 is manufactured such that its upper face 51, which is designed to be oriented toward the object 1, is homothetic to the lower surface 11 of the object 1 to be manufactured, which is opposite the support 5. Between the surface 11 and the surface 51, one or more support blades 7 extend in vertical planes P7 parallel to the vertical axis Z-Z′. The support blades 7 are manufactured by sintering on the support 5 from its upper face 51, before manufacturing of the object 1.

Once the blades 7 are manufactured, the object 1 is manufactured from the upper surfaces 71 of the support blade 7, using the aforementioned traditional sintering method. Once the manufacture of three-dimensional object 1 is complete, the latter rests by its weight in its position on the blades 7, which in turn are supported by the support 5. The layers of powder previously compacted one after the other, bordering the faces of the blades 7, also contribute to maintaining the object 1, to a lesser extent.

The blades 7 make it possible to ensure the continuity between the object 1 and the support 5, while ensuring sufficient mechanical strength for the weight of the object during its manufacture. Advantageously, the support blades 7 have an approximate thickness of one tenth of a millimeter.

In order to remove the object 1 from the manufacturing table 3 when production is complete, a force F is exerted on the object 1, in particular in a lateral direction substantially parallel to the manufacturing table 3. This makes it possible to break the support blades 7 by exerting a shear stress in the blades 7, and thus to separate the object 1 from the support 5.

This force may optionally be applied on the object 1 by means of a force transmitting element 12, and making it possible to transmit the detaching force F without accidentally destroying the surface of the object 1. As shown in FIG. 2, this member has a shape complementary to that of the finished object 1, and allows the application of the detaching force F by surface cooperation, for example between a lateral planar surface 1A of the object 1, and a lateral planar surface 12A of the transmission member 12.

As shown in FIGS. 1 to 4, the number of support blades 7 built prior to manufacturing the object 1 is advantageously proportional to the surface area covered by the object 1 in a plane parallel to the manufacturing table 3. In FIGS. 1 and 2, the width L of the object 1, along an axis Y-Y′ parallel to the manufacturing table 3 and perpendicular to the plane defined by the object 1, is small enough for it to be able to be supported by a single blade 7. The object 1 shown in FIG. 3 has a width L greater than that of the object of FIGS. 1 and 2, therefore a larger surface area, and is supported by two blades 7. The object shown in FIG. 4, which is wider than that of FIG. 3, therefore covers a larger surface area and is supported by two pairs of blades 7. In that case, the blades 7 of each pair are preferably separated by a distance approximately equal to 0.35 mm. The blades can also cover the complete perimeter of the object 1.

Before the application of the force F for detaching the object 1, a rupture primer making it possible to make the blades 7 more fragile can be made by cutting, for example using a circular saw 9, all or part of the edges of the support 5, as for example shown in FIG. 3. This cutting is done near each blade 7, in particular substantially parallel to the manufacturing table 3. This operation is provided to damage the support material 5 on which the blades 7 bear, which facilitates detachment of the object 1 and reduces the force F necessary to break the blades 7.

FIGS. 5 to 13 describe embodiments of the invention implemented during the manufacture of three-dimensional objects 1 with complex shapes and/or having undercut surfaces, i.e., surfaces that are oblique and oriented toward the manufacturing table 3, as is the case for the objects built in FIGS. 8 and 9 and 10 to 13.

FIGS. 5 to 7 show the manufacture of a part comprising a series of several walls 13 perpendicular to the manufacturing table 3 and forming angles relative to each other. In order for the object 1 to be easily detachable from the support 3, the blades 7 are provided in the areas where the walls 13 join in pairs. This avoids obtaining blades 7 with excessive strength, in particular in the event the blades are built parallel to the walls 13 aligned with those walls. In the areas where the walls 13 come together, the object 1 comprises parallel walls 14 that are parallel to each other situated on alternating sides of the object 1. In that case, the support blades 7 are manufactured aligned with those walls 14, and are therefore also parallel to each other.

In the event the finished object 1 has a complex shape, and its geometry does not allow the application of the force F on a single planar surface, because that would result in possible deformations of the object 1, the member 12 may have a suitable shape and not a shape as shown in FIG. 1. In the case of the object 1 of FIGS. 5 to 7, the force transmitting member 12 may be manufactured, optionally by laser sintering, so as to have a profile complementary to that of the object 1. In this way, the force F is exerted on several surfaces of the object 1, in particular the vertical surfaces of the walls 13 and 14, which allows a uniform application of the force F and avoids deformations of the object 1 during its removal.

FIGS. 8 and 9 show an object 1 with a parallelepiped shape, manufactured while being positioned such that two of its faces 101 and 103 are undercut, i.e., they are in an oblique position relative to the manufacturing table 3 such that they form an angle therewith, and are oriented toward the manufacturing table 3.

In this manufacturing scenario, the support blades 7 are manufactured aligned with ridges 105, 106 and 107, which respectively constitute the intersections of the faces 101 and 103 with each other and with the other faces of the object 1. In this case, the support blades 7 extend over the entire width of the object 1, as shown in FIG. 9.

The upper surfaces 513 and 514 of the support 5 are homothetic to the surfaces 101 and 103, which makes it possible to keep a constant height h of the support blades 7.

FIGS. 10 to 13 show an object 1 with a solid cylindrical shape, including a first planar circular face 109, a cylindrical peripheral surface 111 and a second planar circular surface 113. The face 109 constitutes an undercut surface. The lower part 111a of the cylindrical surface 111, delimited by the median generatrices 111b and 111c, which are lines parallel to the central axis X1 of the object 1 and passing through the surface 111, also constitute an undercut surface.

In this manufacturing scenario, one of the support blades 7 is built aligned with the intersection ridge between the face 109 and the lower part 111a of the surface 111.

Another support blade 7 is built aligned with the intersection point between the face 109 and the surface 111 closest to the manufacturing table 3. That support blade 7 extends along the surface 111 up to the generatrices 111b and 111c and is in the shape of an ovoid crown shown in FIG. 13.

The cylindrical object 1 is also supported by still another blade 7, built aligned with a generatrix 111d of the cylindrical surface 111 that is closest to the manufacturing table 3 along the axis Z-Z′. This support blade 7 defines a plane that intersects the cylindrical object 1 at its central axis X1 and separates it into two symmetrical parts.

The upper surfaces 513 and 514 of the support 5 are homothetic to the face 109 and the lower part 111a of the cylindrical surface 111.

It will be noted that, quite strictly speaking, the notion of ridge is a geometric notion, i.e., it is the curve resulting from the intersection of two surfaces. Most of the time from a mechanical or practical point of view, the intersection of two surfaces calls for the presence of a connecting ray. For example, in the case where there is an intersection between a cylindrical surface with a circular base and a plane that is normal to the cylindrical surface, the intersection is a circle; in practice, if we have a connecting ray, the corresponding surface is a surface in the shape of a partial hose or partial toroid. In that case, in order to localize a support blade on that area, we will use a notion of fictitious ridge: this fictitious ridge passes through one of the generatrices of the toroid-shaped surface, which has the particularity of containing the lowest point(s) along a vertical axis.

In order to illustrate this notion, FIG. 14 shows an object 1 identical to that of FIGS. 10 to 13, with the difference that the intersection between the face 109 and the lower part 111a of the cylindrical surface 111 of the object of FIG. 14 has a fictitious ridge 109a as defined above, on which the blades 7 described above in light of FIGS. 10 to 13 are positioned.

This notion of fictitious ridge can extend to any surface that only has fictitious ridges on which it is necessary to position maintaining blades. Thus, FIG. 15 shows an object 1 whose undercut surfaces are in this situation.

In the different manufacturing scenarios described above, the height h of the support blades 7, along the vertical axis Z-Z′, advantageously corresponds approximately to the height of three to seven layers of powder as spread and compacted to manufacture the object 1 by sintering. This blade height allows sufficient mechanical strength to withstand the weight of the object 1 during the manufacture thereof. This height h of the blades 7 makes it possible to leave very little unsolidified powder on the surfaces of the object 1 when its manufacture is complete and the blades 7 are broken. The fact that the upper surfaces of the support 5 are homothetic to the lower surfaces of the object 1 makes it possible to keep a constant height h of the support blades 7.

The height h also makes it possible to ensure the continuity between the object 1 and the support 5, in order to avoid defects related to the heat gradients that may appear in the undercut areas.

As shown in FIGS. 8 to 13, the removal of the finished object 1 may be preceded by cuts 53 made in the support 5, in planes perpendicular to the manufacturing table 3. In practice, these cuts are advantageously made during manufacturing of the support 5 by sintering. Based on the dimensions of the object 1, several cuts 53 can be made in parallel planes, and optionally other cuts in planes perpendicular to each other. FIGS. 9 and 11 to 13 in particular show cuts 53 made aligned with the central axis X1 of the object 1 manufactured in these figures. In all cases, the cuts 53 have a thickness, i.e., a separation between their respective edges, that is substantially equal to the height h of the blades 7: thus, these cuts distribute the support 5 in several fragments, between which these cuts interrupt the mechanical connection, without ruining the overall effect of maintaining the object 1 performed by the support 5.

In the cases shown in FIGS. 8 to 13, the support 5 is for example cut horizontally so as to detach it, with the finished object 1 connected by the blades 7, from the manufacturing table 3. The different fragments of the support can thus be detached one by one from the object 1 by breaking the blades 7, more easily than if the support 5 were detached from the object 1 in a single operation. This operation can for example be performed by locking the object in a maintaining device, then detaching the support fragments using a clamp. In this scenario, the detaching force F is thus not exerted on the object 1, but on the support 5, so as to break the blades 7 by exerting a shear stress.

The scope of the invention is not limited to the objects shown in the figures and may be implemented to manufacture three-dimensional objects with different shapes and that are more or less complex. Furthermore, the different construction configurations of the support blades 7 can be combined in the context of this invention, for a single and same object 1.

1-10. (canceled)

11. A method for producing a three-dimensional object from a powder or from a mixture of powders by sintering and/or laser melting, comprising manufacturing steps consisting of depositing, compacting, then solidifying, in predetermined areas, successive layers of the powder or of the mixture of powders, further comprising the following steps:
a) before implementing the steps of manufacturing the three-dimensional object and from a manufacturing table, manufacturing, by sintering and/or laser melting, a support whereof the surface or the surfaces oriented toward the three-dimensional object to be manufactured are respectively homothetic to opposite surfaces of the three-dimensional object to be manufactured;
b) manufacturing, by sintering and/or laser melting, at least one blade for supporting the three-dimensional object to be manufactured on the support manufactured in step a);
c) manufacturing the three-dimensional object from an upper surface of the or each blade manufactured in step b);
d) when the manufacturing of the three-dimensional object is complete, detaching the three-dimensional object from the support by applying a force to the three-dimensional object or to the support, moving the object and the support relative to one another until the blade or the blades break.

12. The method according to claim 11, wherein before step d), it comprises a step e) consisting of cutting the support near the or each blade.

13. The method according to claim 11, wherein before step d), it comprises a step f) consisting of separating the support into several parts by cuts that are made in the support perpendicular to the manufacturing table and which have a thickness substantially equal to the height of the blade or the blades.

14. The method according to claim 11, wherein in step b), the or each blade is manufactured with a height corresponding to the height of three to seven layers of powder or mixture of powders.

15. The method according to claim 11, wherein the blade or the blades are manufactured in planes perpendicular to the manufacturing table.

16. The method according to claim 11, wherein in step d), the force is applied on a force transmitting element comprising at least one surface cooperating by shape matching with a surface of the three-dimensional object.

17. The method according to claim 11, wherein in the event several three-dimensional objects are manufactured having increasing surface areas in a plane parallel to the manufacturing table, in step b) an increasing number of respective blades is manufactured for those objects.

18. The method according to claim 11, wherein in the event the three-dimensional object comprises one or more oblique faces relative to the manufacturing table and oriented toward the manufacturing table, the blades are manufactured aligned with the intersections of those faces with each other and/or with the other faces of the three-dimensional object.

19. The method according to claim 11, wherein in the event the three-dimensional object comprises one or more rounded faces oriented toward the manufacturing table, the blades are manufactured aligned with one or more generatrices of that or those rounded faces that are closest to the manufacturing table.

20. The method according to claim 11, wherein in the event the three-dimensional object comprises a series of walls forming angles relative to each other in a plane parallel to the manufacturing table, the or each blade is manufactured in a zone where two of those walls come together.
